(19) United States
(12) Patent Application Publication
(10) Pub. No.: US 2009/0177179 A1
(43) Pub. Date: Jul. 9, 2009

(54) Single-Use Packaging System for Storing and Dispensing Multicomponent Materials

(75) Inventor: Juergen Engelbrecht, Hamburg (DE)

Correspondence Address: EDWARDS ANGELL PALMER & DODGE LLP, P.O. BOX 55874, BOSTON, MA, 02205, US

(73) Assignee: S&C Polymer, Silicon-und Composite Spezialiten Gmb, Elmshorn (DE)

(21) Appl. No.: 12/225,896

(22) PCT Filed: Mar. 30, 2007
(86) PCT No.: PCT/EP2007/002894

§ 371 Date: Sep. 30, 2008

(30) Foreign Application Priority Data
Mar. 30, 2006 (DE) 10 2006 015 238.7

(51) Int. Cl. A61J 1/00; A61C 5/06; B65D 25/04

(52) U.S. Cl. 604/416; 220/529

(57) ABSTRACT

The invention relates to a disposable packaging system (2) for storing and dispensing multi-component materials (6), wherein the disposable packaging system (2) has a rigid housing (5) which is separated by films (8) into at least two regions for storing and mixing multi-component materials (6), and wherein the films (8) are arranged as separating membranes (9) in the housing (5) and have weak points (10) which tear open on contact with a sharp object (11) so that the materials (12, 13) separated by the separating membranes (9) mix together in the housing (5).

The invention relates to a disposable packaging system for storing and dispensing multi-component materials and to a method of preparing a directly applicable mixture of a plurality of components of a multi-component material.

Multi-component liquids or pastes or powder/liquid formulations having a special composition are frequently required for dental restorations and medical preparations for patient treatments. Formulations of that kind are, for example, dental adhesives, dental sealing materials, dental filling materials or cementing materials.

For example, before a tooth cavity is filled it is covered with a protective adhesive bonding material. Such a protective bonding material or adhesive material, apart from its adhesive action towards the filling material, also constitutes a seal against penetrating substances that damage or even kill the tooth, such as bacteria or viruses, and accordingly acts as a barrier between the filling material and the body of the tooth.

A customary way of preparing a cavity in that form is to apply a lacquer, which is generally obtainable in small bottles. A small brush is dipped into the bottle and the lacquer is then applied in the cavity. In the case of multi-component adhesives, the lacquer must be mixed on a mixing palette beforehand. The applied material dries and leaves behind the desired adhesive film.

A problem with this method is the risk of cross-contamination when the bottles or even the brush is re-used. Even if the brush is carefully cleaned before being dipped into a bottle again there is a risk of bacterial contamination of the liquid and the material, which can be transmitted to other patients. In the case of multi-component systems, the components can even react prematurely as a result of contamination of the brush.

The adhesives having the greatest range of application for dentists are multi-component systems. The individual components of such multi-component systems are introduced into re-closable stock bottles, so that an amount of material sufficient for several restorations can be kept in reserve or stored.

Depending upon which adhesive system is being used, the amount of effort required of the dentist and assistant is not inconsiderable. The necessary stock containers have to be taken from the storage location, each container has to be opened, the required amount of each component has to be measured out accurately into a mixing vessel, then the stock containers have to be closed again and returned to the storage location. That represents a considerable amount of effort, especially when multi-component materials are being used for medical or dental purposes.

When a two-component system is used a number of times, the associated components are each measured out into a mixing vessel and carefully mixed together before use. Once the individual adhesive components have been mixed, the mixing vessels for the individual components are usually disposed of. The handling and use of such multi-component adhesive systems is generally regarded as inconvenient. In the case of direct restorations, the handling of the described adhesive systems is particularly awkward because the measuring-out and preparation of the restoration material requires a large number of manual operations for measuring-out and mixing.

A further problem lies in the evaporation of readily volatile components from the mixing vessels, which can have an adverse effect. That is especially the case with adhesives containing organic solvents, but it can also occur in the case of water-based and other adhesives. At the time of first opening of all stock containers for the components in question, the desired formulation is still present, but once a significant amount has been removed, that is to say once the containers have been opened several times, evaporation of solvents and readily volatile components reaches a higher level and the compositions differ from the initial proportions. That often results in an increase in viscosity and a change in the mixing ratio, because the concentrations of some individual components have increased as a result of the loss of solvent. Those changes have an adverse effect on handling and quality as well on the strength of the bonding of the adhesives.

When relatively large stock containers are used, further undesirable changes in the components occur. Those changes depend upon the frequency of the opening, removal and closure operation. On each operation there is additionally a risk that the entire stock will be contaminated. For example, during the removal operation the closure cap of the container may be put down in the treatment area or some other non-sterile area. If the contaminated closure cap is put back on the container, the entire stock can become contaminated. A further risk of contamination is presented by the physician or his assistant, whose hands may have been contaminated by contact with the patient and so would soil the closure cap when gripping the cap during the opening, removal and closing operation.

A further disadvantageous characteristic of the known stock containers is the requirement that the adhesive system be correctly measured out by the dentist or his assistant on each individual removal operation. If a component of the system is incorrectly measured out, all the steps, including the correct steps, have to be repeated. If too much adhesive is prepared, the excess must be disposed of. Such disadvantages also arise in the case of paste preparations or powder/liquid preparations, which are currently available in a variety of stock containers.

Accordingly, there is a need for a packaging system for storing and applying multi-component materials, especially for liquid, paste-form or powder/liquid preparations, by means of which the user is freed of the above-mentioned manipulations. For that purpose, a disposable container for single-component adhesives for use by dentists is known from EP 0 967 929 B1. In that specification, a pack is described which contains a filled single-dose container containing a measured amount of about 0.1 ml of adhesive.

Furthermore, the specification DE-U-92 02 654 discloses an ampoule containing a liquid and including a brush. The ampoule is firmly closed and sealed. After opening, the liquid is applied using the brush and the ampoule is closed again by being inserted into a small bottle, similar to a small stock bottle. That system can be used only for single-component systems, however.

The specification DE 102 43 401 A1 discloses a packaging for storing substances, the packaging having a first chamber containing a flowable first substance and a second chamber containing a second substance which is separated fluid-tightly from the first chamber by means of a base film and a top film, which form the chambers. Furthermore, there is a region which joins the first chamber to the second chamber, the top film and the base film being sealed to one another in such a way that pressure exerted on the first chamber from the outside breaks the sealed connection between the two films and a passageway is formed by means of which the two substances are mixed. That packaging has the disadvantage that only flexible films are used which, when a pressure is exerted on the first chamber, bring about mixing of the two substances in the two chambers. In that system there is a risk, on the one hand, that complete and reliable mixing of the two components cannot be achieved and, on the other hand, that during the mixing operation material of the components will escape because of the film material, and accordingly the composition of the mixture will be significantly altered, or the films will tear open, and the material cannot be applied.

The specification EP 0 895 943 B1 discloses a device for storing and dispensing a flowable substance, wherein a container having two chambers again consists of two films. The two chambers can be connected to one another by means of an externally applied pressure, so that the liquid components can be mixed. In order to be able to expel the mixed substance, one of the two chambers has a sealed outlet which can be opened, however, on increased pressure in the chambers, so that the mixture passes out of the chambers between the two films. Such a device is limited to storing and dispensing flowable substances, because mixing powders in practice again has the result that intensive intermixing of the powder with an adhesive liquid cannot be reliably achieved, especially since active mixing using an auxiliary tool is not possible.

Furthermore, devices for storing and applying multi-component dental materials are known in which there is provided a plastics container having a first component and, arranged thereon, a film container containing a further component. When the films of the film container are pierced with an applicator device, however, substantial amounts of the liquid component present in the film container are presumably retained between the films by capillary forces. In the very small quantities that are generally used it is thus not possible to measure out the liquid components exactly, which can lead to problems for the dental materials.

The problem underlying the invention is to overcome the shortcomings and disadvantages in the prior art and to provide the user with a disposable packaging system for storing and dispensing multi-component materials which ensures the purity of the components removed. In addition, the dispenser system should deliver a pre-measured amount, should limit the possibility of evaporation risk and should minimize the risk of cross-contamination. The disposable packaging system for storing and dispensing multi-component materials should also allow simple, uncomplicated but nevertheless intensive mixing. Finally, the system should allow exact measuring-out of liquid components.

That problem is solved by the subject of the independent claims. Advantageous developments of the invention will be found in the dependent claims.

According to the invention, a disposable packaging system for storing and dispensing multi-component materials is provided, the disposable packaging system having a rigid housing. That housing is separated by films into at least two regions for storing and mixing multi-component materials. For that purpose, the films are arranged as separating membranes with media-tightness and bonded connection on or in the housing. In that connection, “media-tight” means especially being sealed with respect to liquid, gaseous and solid substances and mixtures thereof. In addition, the separating films have weak points which tear open on contact with a sharp object, so that the substances of the multi-component materials separated by the separating membranes are able to mix together and can be actively mixed in the rigid housing.

That disposable packaging system has the advantage that the substances are separated from one another by the media-tight films in the housing, without evaporating, until they are used and accordingly do not undergo any alteration. In addition, the purity of the formulations is maintained until they are used, especially since the disposable system ensures that the risk of contamination is reduced. As a result of the disposable packaging system, the possibility of removing a pre-set dose of the components is ensured. In addition, the disposable packaging system ensures that a plurality of components can be stored therein and can be mixed intensively in the rigid housing prior to application.

Furthermore, the risk arising in the case of film packagings that when the components from two separate film chambers are brought together the films will tear open or be damaged, so that either the mixing ratio is altered or a whole sample has to be thrown away, does not arise in the case of the disposable packaging system according to the invention. The rigid housing withstands significantly higher loads than do all the solutions involving film known from the prior art. Moreover, the rigid housing can, with its base region, serve for intensive mixing of the components, and it is also possible to prepare powder mixtures or powder/liquid mixtures which cannot be processed using the known solutions involving film.

In one embodiment of the invention, the housing has a rigid housing base region, rigid housing walls and an opening which is arranged opposite the housing base and has a rim. The opening can be covered by a separating membrane, so that a first component can be stored in the housing base region for a prolonged period. Furthermore, it is possible to mount on the opening a rigid housing extension matched to the cross-section of the housing walls, the housing extension having a further material component of the multi-component materials between two separating membranes. Those two separating membranes seal a housing extension media-tightly. The housing extension and the housing, already prepared for use, can be joined to one another with a bonded connection. If they are to be stored separately, three separating membranes are necessary, that is to say one for the media-tight closure of the opening of the housing and two further separating membranes for sealing the housing extension and its openings media-tightly on both sides after introduction of the second component.

The disposable packaging system according to the invention has the advantage that the amount of the individual components can be measured out exactly even in small amounts of, for example, less than 1 ml per component or less than 0.5 ml per component. In addition, the components are reliably separated from one another and media-tightly enclosed by the separating membranes of the housing, so that a relatively long intermediate storage period is possible without there being any alteration in the properties of the components.

It can be advantageous for the user when pre-measured components are already pre-prepared in a housing base region with walls and a housing extension mounted thereon, so that the user simply has to tear open the separating membranes using a sharp object in order to mix the two components together intensively in the base region of the housing. As a result, confusion between the different multi-component systems for dental or medical use and incorrect combinations thereof are excluded.

Preferably, in such housings having two regions, multi-component materials for a medical glue, or adhesive, or for a medical sealing agent, or sealant, or for a medical filling material or for a medical cement or for a dental sealing lacquer or for flowable medical pastes are provided in the housing regions and/or housing extensions. For that purpose, the multi-component materials can be, for example, in the form of liquid systems, paste systems, powder/liquid systems and/or gelatin systems.

In a preferred disposable packaging system, a plurality of housing extensions are mounted on a beaker-shaped housing. It is thus possible to stack different components of the multi-component materials one on top of the other in the housing extensions and to mix them together in the rigid housing itself shortly before application. In that arrangement, the housing extensions can have different colours and/or markings and/or bar codes so as to ensure that, on removal from storage, the correct components and measured amounts of a multi-component material can be combined with one another.

Furthermore, in accordance with one embodiment of the invention, the rim of the opening of the housing has a closely fitting seat on which the housing extension is mountable so as to be exactly fitting and centred. Such a closely fitting seat can be provided in the housing rim as early as during the manufacture of the housing, during injection-moulding or, in the case of metal housings, during deep-drawing, which facilitates the mounting of a housing extension with further components. This has the further advantage that a plurality of housing extensions having corresponding closely fitting seats can be stacked. In that case, the housing base region with the housing walls can provide a cavity which is suitable and large enough for receiving all the components for a mixing operation, without the torn film material being incorporated into the multi-component substance during the mixing operation.

Furthermore, preferably the separating membrane films have as the weak point a radiating pattern imprinted into the membrane film, the imprinted rays emanating from the centre of the separating membrane. Such a radiating pattern has the advantage that, when the film is torn open, uniform triangular tags or flags are formed which are able to lie against the inner walls of the housing extensions or the beaker-shaped housing and accordingly allow intensive mixing in the housing base region, without film material passing into the mixture. Other patterns are also possible, but care should be taken that no film shreds or film particles of the separating membrane break free when the separating membrane is torn open.

As already mentioned above, the rigid housing and the housing extensions are preferably produced from a polymeric plastics material by means of an injection-moulding process. On the other hand, it is also possible to provide metal housings using a deep-drawing process, it being preferable to use an aluminium alloy.

A method of preparing a directly applicable mixture of a plurality of components of a multi-component material has the following method steps: first of all, a disposable packaging system is provided, the housing base region of a rigid housing and a region between separating membranes in each case having at least one material component of the multi-component material. Then a sharp object is introduced into a weak point of the separating membranes, so that the separating membranes tear open. Finally, the components collecting in the housing base region of the housing are mixed, and then the mixed substance can be removed from the housing base region for application of the mixed substance. Finally, the disposable packaging is disposed of.

That process has the advantage that completely sterile and contamination-free substances can be applied for medical or dental purposes. It has the further advantage that the user need not himself perform any measuring-out, because the components can be delivered in the disposable packaging system in precisely pre-measured form. Furthermore, sterility can be maintained by inserting a sterilised dental tool or a correspondingly aseptic applicator brush having a point in order to mix the components in the rigid housing. Preferably, sterilised medical or dental tools can be used also for removing the mixed substances from the base region.

In order that such a disposable packaging system can be kept in reserve and stored, preferably individual components are introduced into the base region of the housing and the opening of the housing is sealed with media-tightness and bonded connection by means of a separating membrane film.

For example, to store a stock of several components in housing extension pieces it is possible to proceed as follows: first of all an opening of the housing extensions is closed on one side, with media-tightness and bonded connection, then a measured amount of a component is introduced into each of the housing extension pieces and finally the second opening of the housing extension pieces is sealed with media-tightness and bonded connection by means of a second separating membrane film. It is thus possible to store and keep a stock of different measured amounts of a large number of different components which have already been measured out in the optimum way.

For weakening the separating membrane films, it is possible to use a heated imprinting roller or a heated stamping tool with which a weakening imprinted pattern is formed, with heating, in a film material.

The invention will now be explained in greater detail with reference to the accompanying Figures.

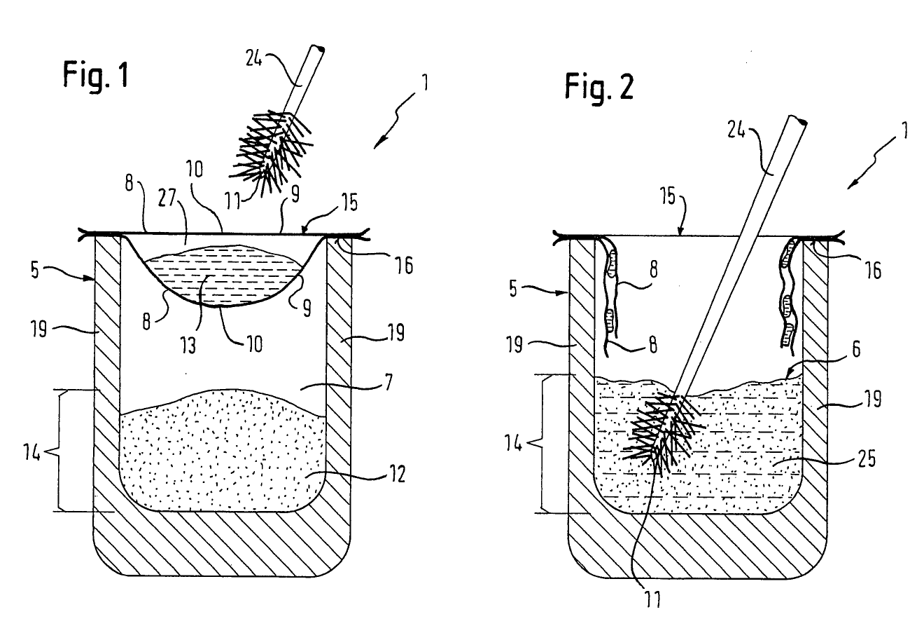

FIG. 1 shows a diagrammatic cross-section through a disposable packaging system of an embodiment in accordance with the prior art prior to mixing of components of a multi-component material;

FIG. 2 shows a diagrammatic cross-section through the disposable packaging system according to FIG. 1 after mixing of components of a multi-component material;

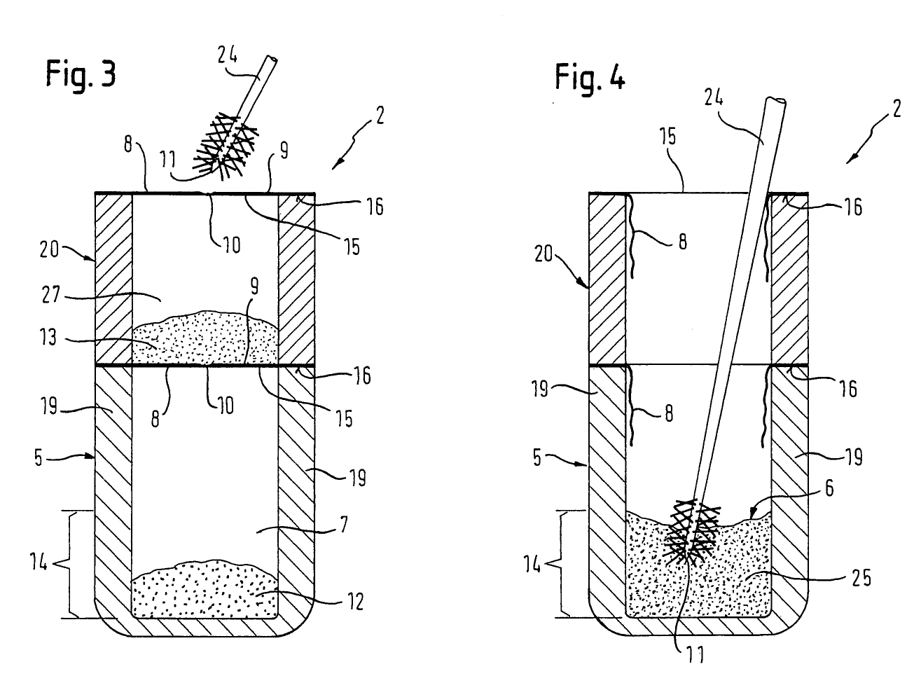

FIG. 3 shows a diagrammatic cross-section through a disposable packaging system of an embodiment of the invention prior to mixing of components of a multi-component material;

FIG. 4 shows a diagrammatic cross-section through the disposable packaging system according to FIG. 3 after mixing of components of a multi-component material;

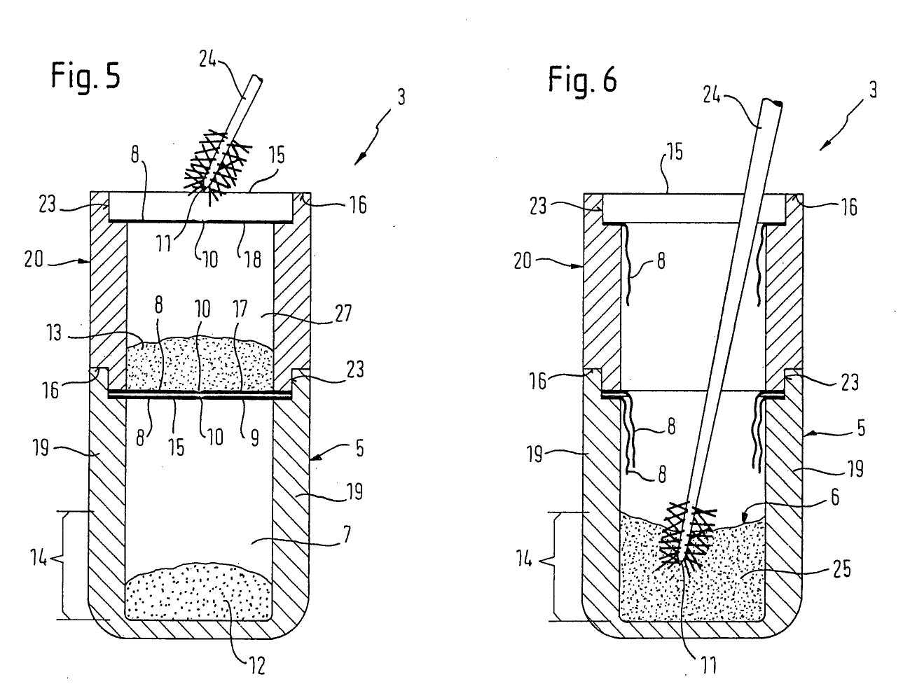

FIG. 5 shows a diagrammatic cross-section through a disposable packaging system of a second embodiment of the invention prior to mixing of components of a multi-component material;

FIG. 6 shows a diagrammatic cross-section through the disposable packaging system according to FIG. 5 after mixing of components of a multi-component material;

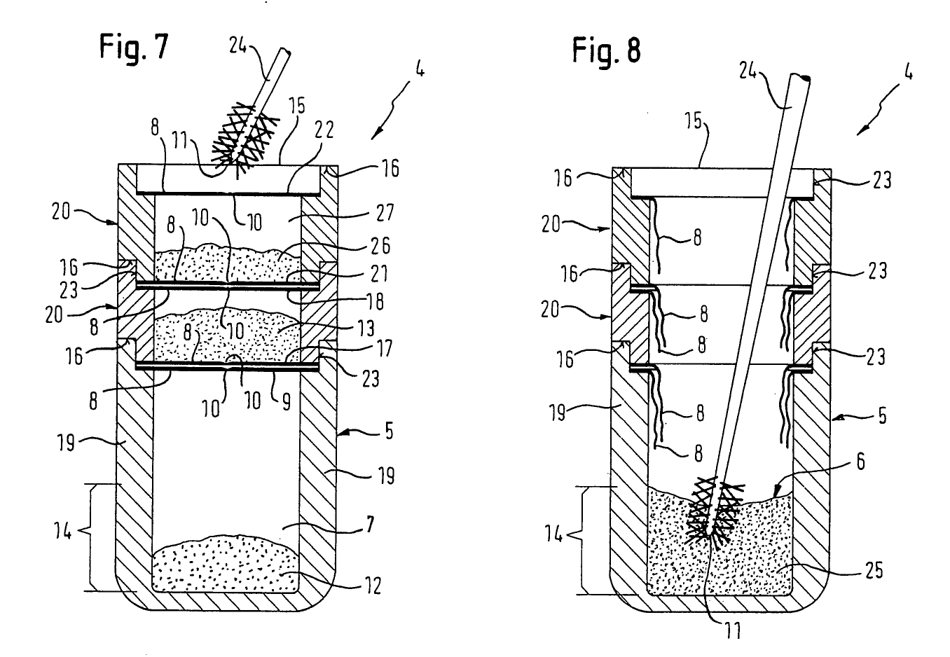

FIG. 7 shows a diagrammatic cross-section through a disposable packaging system of a further embodiment of the invention prior to mixing of components of a multi-component material;

FIG. 8 shows a diagrammatic cross-section through the disposable packaging system according to FIG. 7 after mixing of components of a multi-component material.

FIG. 1 shows a diagrammatic cross-section through a disposable packaging system 1 of an embodiment in accordance with the prior art.

FIG. 2 shows a diagrammatic cross-section through the disposable packaging system 1 according to FIG. 1 after mixing of the components; a proportion of a component remains between the films of the pierced film container.

FIG. 3 shows a diagrammatic cross-section through a disposable packaging system 2 of a first embodiment of the invention prior to mixing of components 12 and 13 of a multi-component material. The housing 5 has for that purpose a housing base region 14 and housing walls 19, there being arranged on the housing walls 19 a housing extension 20 the openings 15 of which are closed by films 8 or separating membranes 9. That housing extension 20 is mounted on the rim 16 of the opening 15 of the housing 5, a separating membrane 9 being fixed between the housing extension 20 and the housing walls 19. That fixing can be effected by means of welding or by means of adhesive bonding.

Inside the housing extension 20, the second component 13 is arranged on the clamped separating membrane 9, while a measured amount of the first component 12 has been introduced into the base region of the rigid housing 5. Because the housing extension 20 is at the top sealed at the upper rim 16 with media-tightness and bonded connection by means of a further separating membrane 9, this disposable packaging containing the components 12 and 13 can be stored until application.

The structuring of the weak point 10 shown in FIG. 3 ensures that no particles from the pieces of film 8 pass into the mixture 25. For example, preferably a radiating pattern can be imprinted into the films 8, so that triangular flags hang down into the container 5 along the housing walls 19 and do not fall into the mixture 25.

FIG. 4 shows a diagrammatic cross-section through the disposable packaging system 2 according to FIG. 3 after mixing of the components to form a multi-component material 6. For that purpose, a sharp tool or an applicator brush 24 having a point 11 is passed through the separating membranes 9, so that the latter tear open at the intended locations and the two components 12 and 13 shown in FIG. 3 collect in the base region 14 of the housing 5 where they can be mixed with the aid of the applicator brush 24 or by means of a suitable tool.

FIG. 5 shows a diagrammatic cross-section through a disposable packaging system 3 in accordance with a second embodiment of the invention prior to mixing of components 12 and 13 of a multi-component material. Elements having the same functions as in the preceding Figures have been given the same reference numerals and are not discussed further. The difference with respect to the preceding disposable packaging system is that the rim 16 of the opening 15 has a closely fitting seat 23, so that an extension 20 can be mounted, centred, on the rim 16 with the closely fitting seat 23 of the beaker-shaped housing 5. At the same time, that closely fitting seat 23 serves for sealing the housing 5 and the housing extension 20 during mixing of the components 12 and 13. For long-term storage, the housing 5 is closed media-tightly in the region of the opening 15 by means of a separating membrane 9 which is joined to the closely fitting seat of the rim 16 with a bonded connection. In addition, for long-term storage of the second component 13 the housing extension 20 is provided with two separating films 17 and 18 which close the two openings of the housing extension 20 media-tightly.

FIG. 6 shows a diagrammatic cross-section through the disposable packaging system 3 in accordance with FIG. 5 after mixing of the components 12 and 13 shown in FIG. 5 to form a multi-component system 6. For that purpose, in this embodiment of the invention three membrane films are pierced or torn open, that is to say the membrane films 9, 17 and 18 shown in FIG. 5. The advantage of such a disposable packaging system is that it is possible to combine different components which are kept and stored in respective media-tightly closed housing extensions 20.

FIG. 7 shows a diagrammatic cross-section through a disposable packaging system 4 of a further embodiment of the invention prior to mixing of components 12, 13 and 26, a measured amount of the third component 26 having been introduced into a further housing extension 20 having a corresponding closely fitting seat 23. FIG. 7 shows the great flexibility and versatility of the disposable packaging system 4 according to the invention as a result of which different measured amounts of a large number of different components can be kept in reserve and stored in the rigid extensions 20 and/or rigid housings which are sealed with media-tightness and bonded connection by means of separating membrane films. For that purpose, the containers, such as housing 5 and extensions 20, can advantageously be made distinguishable from one another by colour codes, lettering, labels, bar codes and/or by microchip markings.

FIG. 8 shows a diagrammatic cross-section through the disposable packaging system 4 according to FIG. 7 after mixing of the components to form a multi-component system 6, the five separating membrane films 9, 17, 18, 21 and 22 shown in FIG. 7 having been torn open with the aid of an applicator brush 24 having a point 11, and the stacked series of components 12, 13 and 26 shown in FIG. 7 having collected in the base region 18 of the rigid beaker-shaped housing 5 and having been mixed with the aid of the applicator brush 24.

### LIST OF REFERENCE NUMERALS

1 disposable packaging system (prior art)
2 disposable packaging system (first embodiment)
3 disposable packaging system (second embodiment)
4 disposable packaging system (third embodiment)
5 housing
6 multi-component material
7 region (of the housing)
8 film or film material
9 separating membrane or separating membrane film
10 weak point
11 sharp object
12 substance or component (base)
13 substance or component (opening)
14 housing base region
15 opening
16 rim of opening
17 separating membrane
18 separating membrane
19 housing walls
20 housing extension or housing extension piece
21 separating membrane
22 separating membrane
23 closely fitting seat
24 brush
25 mixture or mixed substance
26 third component
27 second region

1-25. (canceled)

26. A disposable packaging system for storing and dispensing multi-component materials, wherein the disposable packaging system is separated by films into at least two regions for storing and mixing multi-component materials, wherein the films are provided in the form of separating membranes with media-tightness and bonded connection, and wherein the separating membranes can have weak points which tear open on contact with a sharp object, so that the substances of the multi-component materials separated by the separating membranes mix together,
wherein
the disposable packaging system has a rigid housing base region, rigid housing walls and an opening which is arranged opposite the housing base and has a rim, a material component of the multi-component material being arranged in the housing base region, the opening being coverable by a separating membrane, and there being mounted on the opening a rigid housing extension matched to the cross-section of the housing walls, and the housing extension having a further material component of the multi-component material between two separating membranes which seal the housing extension media-tightly.

27. A disposable packaging system according to claim 26, wherein the disposable packaging system has a plurality of housing extensions.

28. A disposable packaging system according to claim 26 wherein the rim of the opening has a closely fitting seat on which a housing extension is mounted so as to be exactly fitting and centred.

29. A disposable packaging system according to claim 27 wherein the rims of the openings of the housing extension have closely fitting seats on which, centred, a plurality of housing extensions having corresponding closely fitting seats can be stacked.

30. A disposable packaging system according to claim 26 wherein the separating membrane films have as weak points a radiating pattern imprinted into the membrane films, the imprinted rays emanating from the centre of the separating membrane.

31. A disposable packaging system according to claim 26 wherein the separating membranes are joined to the rim of the opening with a bonded connection.

32. A disposable packaging system according to claim 26 wherein the separating membranes are adhesively bonded to the rim of the opening.

33. A disposable packaging system according to any claim 30 wherein the separating membranes are welded to the rim of the opening.

34. A disposable packaging system according to claim 30 wherein the separating membrane is clamped between the rim of the opening and the extension.

35. A disposable packaging system according to claim 26 wherein the housing base region, the housing walls and the housing extensions have a polymeric plastics material.

36. A disposable packaging system according to claim 26 wherein the housing base region, the housing walls and optionally also the housing extensions have an aluminium alloy.

37. A disposable packaging system according to claim 26 wherein the multi-component materials have a medical glue, or adhesive, or a medical sealing agent, or sealant, or a medical filling material or a medical cement or a dental sealing lacquer or flowable medical pastes in the housing base regions and/or between separating membranes.

38. A disposable packaging system according to claim 26 wherein the multi-component materials have liquid systems, paste systems, powder/liquid systems and/or gelatin systems.

39. A disposable packaging system according to claim 26 wherein the disposable packaging system for mixing and dispensing the multi-component materials has a brush having a point.

40. A method of preparing a directly applicable mixture of a plurality of components of a multi-component material, the method comprising:
providing a disposable packaging system in accordance with claim 26, the housing base region and the region between the separating membranes in each case having at least one material component;
introducing a sharp object into the weak point of the separating membranes;
mixing the components that collect in the housing base region; and
removing the mixed substance from the housing base region.

41. The method of claim 40 further comprising applying the mixed substance.

42. The method of claim 40 further comprising disposing of the disposable packaging.

43. The method of claim 40 wherein a dental tool or an applicator brush having a point is used as the sharp object.

44. The method according to claim 40 wherein a dental tool is used for removing the mixed substance from the housing base region.

45. The method according to claim 40 wherein for storage, individual components are introduced into the housing base region and the opening is sealed with media-tightness and bonded connection by a separating membrane film.

46. The method according to claim 40 wherein for storing a stock of a plurality of components housing extension pieces are closed on one side, with media-tightness and bonded connection, then a measured amount of a component is introduced into each of the housing extension pieces and finally the housing extension pieces are sealed with media-rightness and bonded connection by means of a second separating membrane film.

47. The method according to claim 40 wherein for weakening the separating membrane films there is used a heated imprinting roller or a heated stamping tool with which a weakening imprinted pattern is formed, with heating, in the film material.

48. The method according to claim 46 wherein for producing the housing base, the housing walls and the housing extensions from plastics material an injection-moulding process is used.

49. The method according to claim 46 wherein for producing the housing base, the housing walls and the housing extensions from an aluminium alloy a deep-drawing process is used.

50. The method according to claim 46 wherein for the bonded and media-tight connection of the separating membrane films to the rim of the opening and/or the rims of the housing extensions, the separating membrane films are attached by adhesive bonding or welding.

51. The method according to claim 46 wherein as multi-component materials the components of a medical glue or of a medical sealing agent or of a medical filling material or of a medical cement or of a dental sealing lacquer or of a flowable medical paste are introduced in measured amounts into the housing base regions and/or into the housing extensions.

52. A method for micro-dispensing and/or application of multi-component materials (6) in medicine or dentistry, comprising using a disposable packaging system of claim 26.
